(19) United States
(12) Patent Application Publication
(10) Pub. No.: US 2026/0217085 A1
(43) Pub. Date: Jul. 30, 2026

(54) METHOD AND DEVICE FOR GENERATING HEATING POWER IN A VEHICLE WITH AN ELECTRIC DRIVE

(71) Applicant: AUDI AG, Ingolstadt (DE)

(72) Inventors: Sebastian HEBER, Beilngries (DE); Lars HELLING, Dollnstein (DE)

(21) Appl. No.: 19/461,518

(22) Filed: Jan. 27, 2026

(30) Foreign Application Priority Data
Jan. 29, 2025 (DE) 102025103096.0

(51) Int. Cl. B60H 1/00; B60H 1/03; H02P 29/62

(52) U.S. Cl. CPC B60H 1/00392; B60H 1/03; H02P 29/62

(57) ABSTRACT

A method of generating heating power in a vehicle with an electric drive, for example, including an induction machine. The method includes: detecting a heating power demand by a controller of the vehicle, generating heat by increasing main magnetic flux in the electric drive beyond a predetermined loss-optimal operation, and transferring the heat to a thermal heating system by way of a heat exchanger.

### BACKGROUND

### TECHNICAL FIELD

The technical field of the disclosure relates to methods and devices for generating heating power in a vehicle with an electric drive.

### DESCRIPTION OF THE RELATED ART

The prior art comprises several approaches for generating heating power in vehicles with an electric drive. Known methods use the waste heat from electric drives by operating them in the loss-optimized operating range or by making specific adjustments to the operating parameters.

CN112297868A discloses a method and a device for active heating control of a hybrid electric motor.

CN117081464A discloses an active heating control method for motors that enables heat generation by adjusting a target current vector.

CN113022262A discloses a control method and a device for an electric drive system of a vehicle, wherein waste heat of the drive system is used to cover the heating demand.

### BRIEF SUMMARY

Embodiments of the disclosure provide a method that enables efficient and flexible generation of heating power in a vehicle.

### DETAILED DESCRIPTION

The disclosure relates to a method for generating heating power in a vehicle with an electric drive, comprising detecting a heating power demand by a control unit of the vehicle, increasing a main magnetic flux in the electric drive, preferably an induction machine, beyond a specified loss-optimized operation in order to generate additional heat, and transferring the additionally generated heat to a thermal heating system by way of a heat exchanger. In one or more implementations, the control unit is a controller having a microprocessor that includes a processor and a memory storing instructions that, when executed by the processor, cause the microprocessor to perform the acts of the control unit described herein.

The main magnetic flux refers to the magnetic flux density in the electric drive, which is decisive for torque formation and heat generation. The electric drive is a device for converting electrical energy into mechanical work, preferably an induction machine that operates by way of a rotating magnetic field. An induction machine is an electric machine that can be operated as a motor and wherein the rotor rotates at a different rotational speed than the magnetic field of the stator, resulting in a so-called slip. It belongs to the group of rotating-field machines and is based on the principle of electromagnetic induction, in which currents are induced in the rotor by the changing magnetic field of the stator, which generates its own magnetic field and interacts with the stator field. The heat exchanger is a device that transfers the heat from the electric drive to the thermal heating system by transferring thermal energy from one medium to another.

The advantages of the method lie in the efficient use of waste heat from the electric drive to provide heating power in the vehicle. The use of a heat exchanger enables targeted transfer of the generated heat to the thermal heating system.

Advantageously, the main magnetic flux may be increased while the vehicle is stationary in order to generate heat for the thermal heating system. Vehicle standstill describes an operating state in which no driving force is transmitted from the electric drive to the wheels of the vehicle. This means that the heating power can be provided independently of the movement of the vehicle.

This ensures that, for example, the interior heating system of the vehicle is supplied with sufficient heat, even when the vehicle is stationary, for example, when it is parked.

Advantageously, the control unit may send a signal via a communication protocol to the power electronics of the drive in order to increase the main magnetic flux. The communication protocol describes standardized transmission of control signals, while the power electronics handle the conversion of the control signals to modulate the main flux.

Advantageously, the method can be applied to a vehicle with several electric drives, preferably with several induction machines, so that the heat generated for the thermal heating system is increased. Several electric drives enable parallel generation of heating power, which increases the overall performance of the system.

This allows the heating output to be adapted to greater thermal requirements, for example, in larger vehicles or at extremely low ambient temperatures.

Advantageously, the control unit may regulate the heating power demand depending on the operating conditions of the electric drive, such as a torque, speed, voltage, and temperature of the electric drive, wherein the operating conditions are detected by corresponding sensors. The operating conditions comprise physical and electrical parameters of the drive that influence its function and thermal output. Torque is the mechanical force generated by the drive, while rotational speed describes the rotational speed of the drive. Voltage and temperature are electrical and thermal parameters that influence operation and heat generation.

This ensures dynamic adjustment of the heating output to the current operating conditions of the vehicle.

Advantageously, the control unit may have an additional energy management function of the vehicle, so that the transfer of the generated heat to the thermal heating system is synchronized with other heat sources of the vehicle. The energy management function is a system that coordinates the flow of energy between different energy sources and energy consumers of the vehicle.

This ensures optimum use of all available heat sources in the vehicle, which increases the efficiency of the overall system and reduces energy consumption.

Advantageously, a higher-level vehicle, energy, thermal management, and/or drive function of the control unit may determine the heating power demand and transmit a control signal, preferably by way of a bus device, to a pulse inverter and/or to power electronics of the electric drive, so that the main magnetic flux is increased by a specified minimum value. The bus device refers to an internal vehicle network for transmitting control signals, while the pulse inverter modulates the electrical power.

A pulse inverter is an electronic circuit or device that converts direct current into alternating current and can precisely control the frequency, voltage, and current of the output. It is often used in drive systems of electric machines to control the power electronics and to achieve the required operating parameters of the machine.

Pulse inverters typically operate by pulse width modulation (PWM), in which a series of variable-width voltage pulses is generated to approximate a desired AC voltage or current waveform.

This ensures that a minimum level of heating power is provided to meet the comfort and safety requirements of the vehicle, even when energy demand fluctuates.

A further subject matter of the disclosure is a device for generating heating power in a vehicle with an electric drive using the method described above, comprising a control unit configured to detect a heating power demand of the vehicle and power electronics coupled to the electric drive, preferably an induction machine, wherein the control unit is configured to transmit a signal to the power electronics via a communication protocol, so that a main magnetic flux of the electric drive is increased beyond a predetermined loss-optimal operation, thereby generating additional heat for a thermal heating system.

One advantage of the device is that it makes efficient use of existing electric drives to generate heating power without the need for additional heating systems.

Advantageously, the device may be designed in such a way that the power electronics are suitable for operation when the vehicle is stationary. Here, the main magnetic flux of the electric drive is increased in a targeted manner, even when stationary, in order to generate heat for the thermal heating system.

Advantageously, the device may be equipped with sensors that detect operating conditions of the electric drive, such as torque, speed, voltage, and/or temperature, wherein the control unit can regulate the main magnetic flux based on these operating conditions.

This enables precise adjustment of the heating output to the current operating conditions of the vehicle.

German application no. 102025103096.0, filed January 29, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method of generating heating power in a vehicle with an electric drive, comprising:
detecting a heating power demand by a controller of the vehicle;
generating heat by increasing main magnetic flux in the electric drive beyond a predetermined loss-optimal operation; and
transferring the heat to a thermal heating system by way of a heat exchanger.

2. The method according to claim 1, wherein the electric drive includes an induction machine.

3. The method according to claim 1, wherein the generating heat includes increasing the main magnetic flux in the electric drive while the vehicle is stationary.

4. The method according to claim 1, further comprising:
transmitting, by the controller, a control signal to power electronics of the electric drive via a communication protocol, wherein the control signal causes the power electronics of the electric drive to increase the main magnetic flux of the electric drive.

5. The method according to claim 1, wherein the vehicle includes a plurality of electric drives.

6. The method according to claim 5, wherein the plurality of electric drives includes a plurality of induction machines.

7. The method according to claim 1, further comprising:
regulating, by the controller, the heating power demand based on operating conditions of the electric drive detected by a plurality of sensors.

8. The method according to claim 7, wherein the operating conditions of the electric drive include torque, rotational speed, voltage, and/or temperature of the electric drive.

9. The method according to claim 1, further comprising:
synchronizing, by the controller, the transferring of the heat to the thermal heating system with one or more heat sources of the vehicle other than the electric drive.

10. The method according to claim 1, further comprising:
determining, by the controller, the heating power demand; and
transmitting, by the controller, a control signal to a pulse inverter and/or to power electronics of the electric drive, wherein the control signal causes the pulse inverter and/or power electronics of the electric drive to increase the main magnetic flux in the electric drive by a specified minimum value.

11. The method according to claim 10, wherein the controller transmits the control signal to the pulse inverter and/or power electronics of the electric drive by way of a bus device.

12. A device that generates heating power in a vehicle with an electric drive, the device comprising:
a controller that, in operation, detects a heating power demand of the vehicle; and
power electronics coupled to the electric drive,
wherein the controller, in operation, transmits a control signal to the power electronics via a communication protocol,
wherein the control signal causes main magnetic flux of the electric drive to increase beyond a predetermined loss-optimal operation and generate heat that is transferred to a thermal heating system.

13. The device according to claim 12, wherein the electric drive includes an induction machine.

14. The device according to claim 12, wherein the controller, in operation, controls the power electronics to operate when the vehicle is stationary, and wherein the main magnetic flux of the electric drive is increased when the vehicle is stationary and the heat is generated and transferred to the thermal heating system.

15. The device according to claim 12, wherein the controller is connected to sensors that, in operation, detect operating conditions of the electric drive, and wherein the controller, in operation, regulates the main magnetic flux based on the operating conditions, so that the heat generated by the electric drive is adapted to the heating power demand of the thermal heating system.

16. The device according to claim 15, wherein the operating conditions of the electric drive include torque, rotational speed, voltage, and/or temperature.
